(19) United States
(12) Patent Application Publication
(10) Pub. No.: US 2008/0264535 A1
(43) Pub. Date: Oct. 30, 2008

(54) COVER FOR PORTABLE ELECTRONIC DEVICE AND METHOD FOR MAKING SAME

(75) Inventors: TZU-CHENG YU, Shindian (TW); YAO-HAO CHANG, Shindian (TW)

Correspondence Address: PCE INDUSTRY, INC.;ATT. CHENG-JU CHIANG, 458 E. LAMBERT ROAD, FULLERTON, CA, 92835, US

(73) Assignee: SUTECH TRADING LIMITED, Tortola (VG)

(21) Appl. No.: 11/946,270

(22) Filed: Nov. 28, 2007

(30) Foreign Application Priority Data
Apr. 25, 2007 (CN) 200710074219.6

(51) Int. Cl. B65D 65/02; B29C 45/00

(52) U.S. Cl. 150/165; 425/542

(57) ABSTRACT

A cover (200) for portable electronic device includes a foil film (30) and a housing (40). The foil film includes a transparent view panel (31) and a keypad (33) integrally formed thereon. The housing is integrally formed with the foil film. The housing has a view panel opening (41) and a keypad opening (43) defined therein. The view panel opening and the keypad opening respectively correspond to the view panel and the keypad of the foil film. A method for making the cover includes the following steps: forming a foil film by injection molding, the foil film having a transparent view panel and a keypad; and integrally forming a housing on an inner surface of the foil film by injection molding, the housing having a view panel opening and a keypad opening respectively corresponding to the view panel and the keypad of the foil film.

### BACKGROUND

1. Technical Field

The present invention relates to cover for portable electronic device and a method for making the cover and, particularly, to a cover for portable electronic device having an effective hermetic performance and a timesaving method for making the cover.

2. Description of the Related Art

With the development of wireless communication and information processing technology, portable electronic devices, such as mobile phones, personal digital assistants (PDAs), and handheld computers, are now in widespread use. These portable electronic devices enable consumers to enjoy the convenience of high technology services, almost anytime and anywhere.

As shown in FIG. 1, a typical top cover 10 of a portable electronic device has a housing 12, a view panel 14, and a keypad 16. The view panel 14 is a transparent plastic or glass lens, and is fixed to the housing 12 to protect display elements of the portable electronic device from being damaged. The keypad 16 includes a plurality of keycaps formed thereon, and is mounted to the housing 12. Typically, the housing 12, the view panel 14 and the keypad 16 are not formed integrally. The view panel 14 and the keypad 16 are adhered to the housing 12 by adhesive.

However, the method of adhering the view panel 14 and the keypad 16 to the housing 12 cannot reach a desired level of waterproof and dustproof performance, moisture and dust in the ambient air may go through a joint area of the aforesaid components and enter into the portable electronic device, which causes damage to the portable electronic device. In addition, the housing 12, the view panel 14 and the keypad 16 are made in separate processes, which prolongs the time needed to produce the top cover 10.

What is needed, therefore, is an improved cover for portable electronic device and a method for making the cover to overcome the above-described shortcomings.

### SUMMARY

In one aspect, a cover for portable electronic device is provided. The cover includes a foil film and a housing. The foil film includes a transparent view panel and a keypad integrally formed thereon. The housing is integrally formed with the foil film. The housing has a view panel opening and a keypad opening defined therein. The view panel opening and the keypad opening respectively correspond to the view panel and the keypad of the foil film.

In another aspect, a method for making the cover is provided. The method includes the following steps: forming a foil film by injection molding, the foil film having a transparent view panel and a keypad; and integrally forming a housing on an inner surface of the foil film by injection molding, the housing having a view panel opening and a keypad opening respectively corresponding to the view panel and the keypad of the foil film.

Other advantages and novel features will become more apparent from the following detailed description when taken in conjunction with the accompanying drawings.

### BRIEF DESCRIPTION OF THE DRAWINGS

Many aspects of the present cover for portable electronic device and method for making same can be better understood with reference to the following drawings. The components in the drawings are not necessarily drawn to scale, the emphasis instead being placed upon clearly illustrating the principles of the cover for portable electronic device and method for making same. Moreover, in the drawings, like reference numerals designate corresponding parts throughout the several views.

FIG. 1 is a disassembled perspective view of a top cover for a typical portable electronic device;

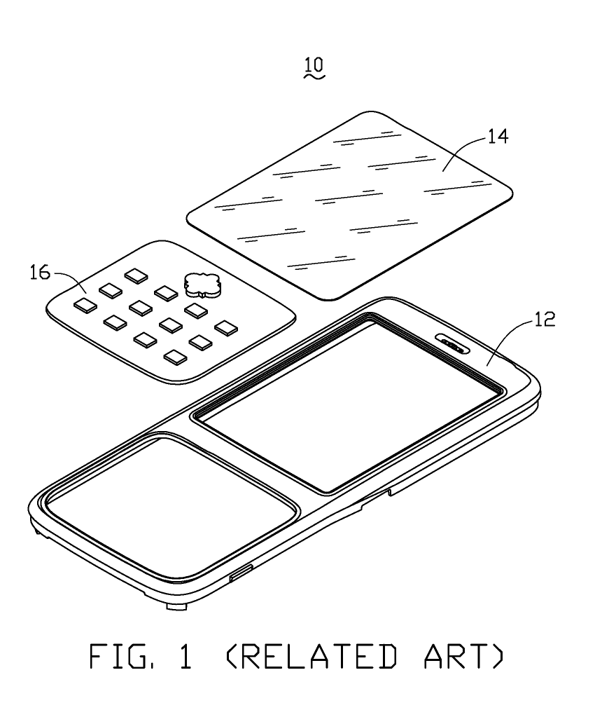

FIG. 2 is an assembled perspective view of a front cover for a portable electronic device of the present invention;

FIG. 3 is similar to FIG. 2, but showing another aspect of the front cover;

FIG. 4 is an exploded perspective view of the front cover; and

FIG. 5 is similar to FIG. 4, but showing another aspect of the front cover.

### DETAILED DESCRIPTION OF THE PREFERRED EMBODIMENT

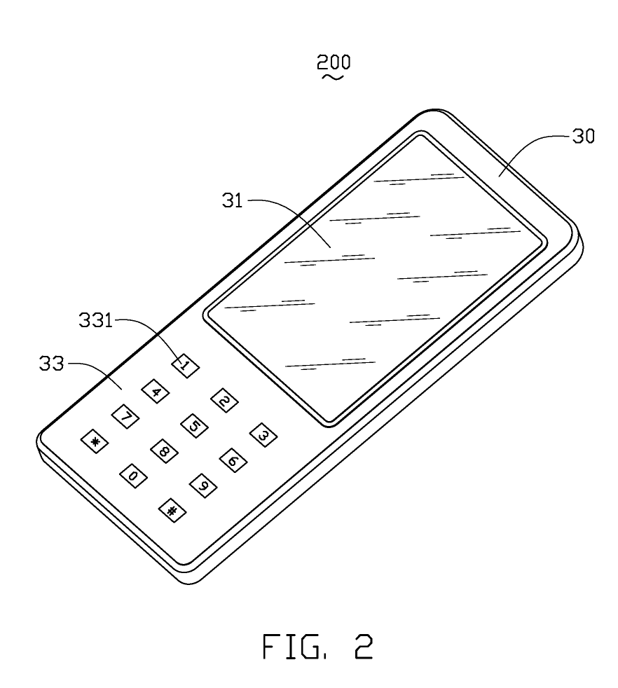

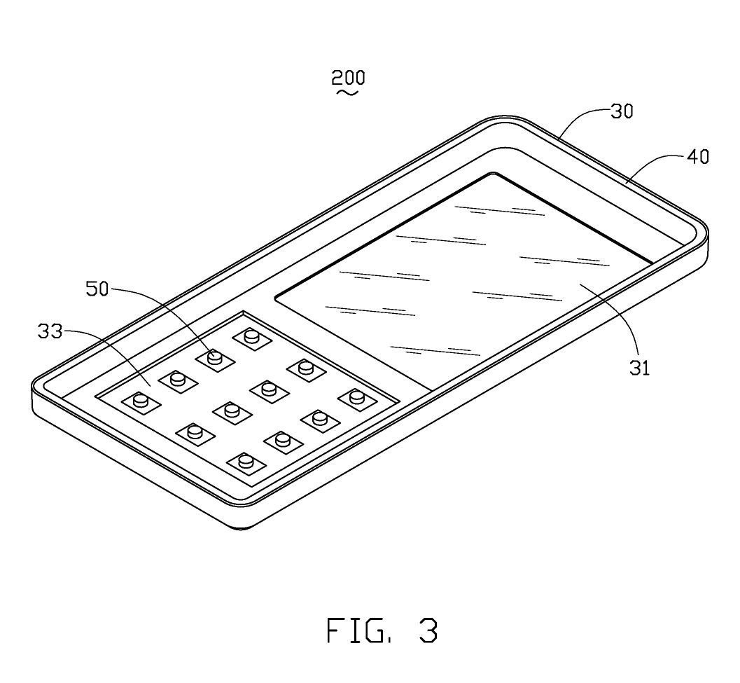

The present cover is suitable for portable electronic devices such as mobile phones, PDAs, and handheld computers. Referring now to the drawings in detail, FIGS. 2-5 schematically show a front cover 200 for a portable electronic device. The front cover 200 includes a foil film 30, a housing 40 (shown in FIG. 3) and a plurality of buttons 50 (shown in FIG. 3). The housing 40 and the buttons 50 are integrally formed on the foil film 30 so that the foil film 30 can protect the housing 40 from abrasion.

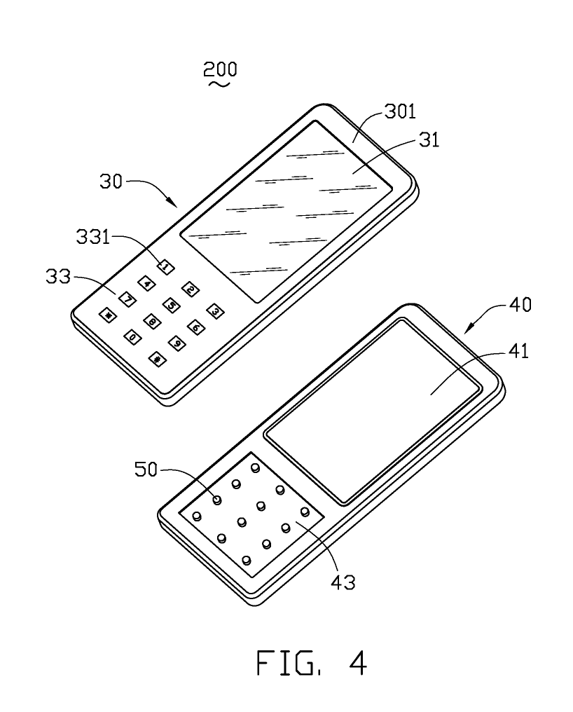

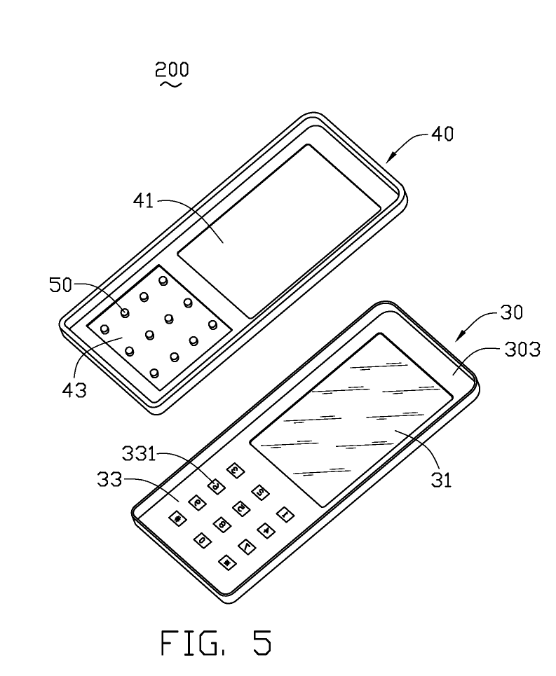

Regarding to FIGS. 4 and 5, the foil film 30 is made of a transparent wearable thermoplastic resin such as polyethylene terephthalate (PET), and is preferably formed by injection molding (also called insert molding) and in mold lamination (IML, also called in mold labeling). The foil film 30 has an outer surface 301, an inner surface 303 on the opposite side of the outer surface 301, a transparent view panel 31, and a keypad 33. The view panel 31 is disposed at a top portion of the foil film 30, and is transparent so that information displayed on a display unit (not shown) of the portable electronic device can be seen therethrough. The keypad 33 is disposed at a bottom portion of the foil film 30, and includes a plurality of keys 331 configured to input information. In the preferred embodiment, the keys 331 of the keypads 33 are flat and flush to the outer surface 301 of the foil film 30. It is to be understood that, the keys 331 of the keypad 33 also can be configured (e.g. structured and arranged) to protrude outwards from the outer surface 301 of the foil film 30. The foil film 30 is elastic, so that the keys 331 can deform according to an external force applied thereto, and rebound to an initial state after the external force is withdrawn. The inner surface 303 of the foil film 30 is printed with numbers, characters, or symbols, which are placed corresponding to the keys 331 to indicate functions of the keys 331, such as numbers for inputting telephone numbers, and characters for inputting character information. The remaining portions other than the view panel 31 and the keypad 33 of the inner surface 303 of the foil film 30 can be printed with pictures, figures or patterns for aesthetic and decoration purpose of the front cover 200.

The housing 40 is made of thermoplastic resin such as acrylonitrile butadiene styrene (ABS), or polycarbonate (PC), and is preferable a plate having a same outer shape to the foil film 30. The housing 40 has a view panel opening 41 and a keypad opening 43 defined therein. The housing 40 is integrally formed on the foil film 30 by injection molding the thermoplastic resin to the inner surface 303 of the foil film 30 with the view panel opening 41 and the keypad opening 43 respectively corresponding to the view panel 31 and the keypad 33.

As shown in FIG. 3, the buttons 50 are made of thermoplastic resin such as acrylonitrile butadiene styrene (ABS), or polycarbonate (PC), and are integrally formed on the inner surface 303 of the foil film 30 with each button 50 corresponding to a key (or key symbol) 331. The buttons 50 protrude inwards from the inner surface 303 of the foil film 30, and are configured to correspond to a respective electric contact dome formed at a keymat circuit (not shown) of the portable electronic device. When a key 331 is pressed, the key 331 deforms inwards, the corresponding button 50 jointly passes through the keypad opening 43 of the housing 40 and presses the corresponding electric contact dome thereby triggering an input signal.

An exemplary method for making the front cover 200 is provided. The method includes following steps:

forming a foil film 30 by injection molding, the foil film 30 having a transparent view panel 31 and a keypad 33;
printing numbers, characters, and symbols on an inner surface 303 of the foil film 30, with the numbers, characters, and symbols respectively corresponding to a key 331 of the keypad 33; and
integrally forming a housing 40 and a plurality of buttons 50 on the inner surface 303 of the foil film 30 by injection molding, the housing 40 having a view panel opening 41 and a keypad opening 43 respectively corresponding to the view panel 33 and the keypad 34 of the foil film 30, the buttons 50 respectively corresponding to the keys (key symbols) 331 of the keypad 33, protruding from the inner surface 303 of the foil film 30, and passing through the keypad opening 43.

According to the front cover 200 for portable electronic device, the view panel 31 and the keypad 33 are integrally formed on the foil film 30 and the housing 40 is fixed to the foil film 30 by injection molding. Thus, in the process of making the front cover 200, there is no need to apply adhesive to housing 40, and place the view panel 31 and keypad 33 to the housing 40 thereby adhering the view panel 31 and the keypad 33 to the housing 40. Hence, the method of making the front cover 200 is simple and timesaving. In addition, the foil film 30 and the housing 40 are joined together without gap. Therefore, waterproof and dustproof performance of the front cover 200 can be dramatically improved.

It is to be understood, however, that even though numerous characteristics and advantages of the present invention have been set forth in the foregoing description, together with details of the structure and function of the present invention, the disclosure is illustrative only, and changes may be made in detail, especially in matters of shape, size, and arrangement of parts within the principles of present invention to the full extent indicated by the broad general meaning of the terms in which the appended claims are expressed.

What is claimed is:

1. A cover for portable electronic device, comprising:
a foil film comprising a transparent view panel and a keypad having keys integrally formed thereon; and
a housing integrally formed with the foil film, the housing having a view panel opening and a keypad opening defined therein with the view panel opening and the keypad opening respectively corresponding to the view panel and the keypad of the foil film.

2. The cover as claimed in claim 1 further comprising a plurality of buttons, wherein the buttons are integrally formed on the foil film, at same side to the housing, and the buttons corresponds to the keypad.

3. The cover as claimed in claim 2, wherein the buttons protrude from the foil film and pass through the keypad opening.

4. The cover as claimed in claim 3, wherein the foil film is made of a transparent wearable thermoplastic resin.

5. The cover as claimed in claim 4, wherein the thermoplastic resin is polyethylene terephthalate.

6. The cover as claimed in claim 2, wherein the housing and buttons are made of thermoplastic resin.

7. The cover as claimed in claim 6, wherein the thermoplastic resin comprises one item selected from the group consisting of acrylonitrile butadiene styrene and polycarbonate.

8. The cover as claimed in claim 7, wherein the keypad comprises a plurality of keys printed with numbers, characters or figures.

9. The cover as claimed in claim 8, wherein the numbers, characters or figures are printed on an inner surface contacting with the housing of the foil film.

10. The cover as claimed in claim 9, wherein the keys are flat and flush to an outer surface of the foil film.

11. The cover as claimed in claim 8, wherein the keys protrude from an outer surface of the foil film.

12. A method for making a cover of claim 1, comprising the following steps:
forming a foil film by injection molding, the foil film having a transparent view panel and a keypad having keys; and
integrally forming a housing on an inner surface of the foil film by injection molding, the housing having a view panel opening and a keypad opening respectively corresponding to the view panel and the keypad of the foil film.

13. The method of making a cover as claimed in claim 12 further comprising a step before forming the housing, to print numbers, characters, and figures on the inner surface of the foil film, with the numbers, characters, and figures respectively corresponding to keys of the keypad.

14. The method of making a cover as claimed in claim 12 further comprising a step after forming the housing, to integrally form a plurality of buttons on the inner surface of the foil film by injection molding, and the buttons respectively corresponding to the keypad.

15. The method of making a cover as claimed in claim 14, wherein the buttons protrude from the inner surface of the foil film and pass through the keypad opening.
